(19) United States
(12) Patent Application Publication
(10) Pub. No.: US 2022/0255371 A1
(43) Pub. Date: Aug. 11, 2022

(54) OCCUPANT ADJUSTABLE SINGLE COIL WIRELESS CHARGER

(71) Applicant: APTIV TECHNOLOGIES LIMITED, St. Michael (BB)

(72) Inventor: George Powell, Cortland, OH (US)

(73) Assignee: APTIV TECHNOLOGIES LIMITED, St. Michael (BB)

(21) Appl. No.: 17/171,517

(22) Filed: Feb. 9, 2021

(51) Int. Cl. H02J 50/90; H02J 7/00; H02J 7/02; H02J 50/10

(52) U.S. Cl. CPC H02J 50/90; H02J 50/10; H02J 7/02; H02J 7/0044

(57) ABSTRACT

Inductive charging systems and methods include providing a wireless charging pad comprising a single transmitter coil that, when active, is configured to inductively couple with a receiver coil of a wireless device placed on the wireless charging pad to wirelessly transfer power thereto, providing a control system configured to adjust a position of the single transmitter coil within the wireless charging pad, and mechanically operating, by a human operator, the control system to adjust the position of the single transmitter coil within the wireless charging pad.

### FIELD

The present disclosure generally relates to inductive charging and, more particularly, to an occupant adjustable single coil wireless charger, such as for automotive applications.

### BACKGROUND

Inductive charging is a type of wireless power transfer that uses electromagnetic induction to provide electrical energy to mobile or wireless devices (e.g., mobile phones). Conventional wireless charging pads typically comprise a plurality of smaller, closely spaced transmitter coils (i) to more closely match the size of wireless device receiver coils for better inductive coupling and (ii) to allow for spatial freedom in positioning the wireless device. Providing a plurality of transmitter coils, however, increases costs. Thus, while conventional inductive charging systems do work well for their intended purpose, there exists an opportunity for improvement in the relevant art.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect of the present disclosure, an inductive charging system is presented. In one exemplary implementation, the inductive charging system comprises a wireless charging pad comprising a single transmitter coil that, when active, is configured to inductively couple with a receiver coil of a wireless device placed on the wireless charging pad to wirelessly transfer power thereto, and a control system configured to be mechanically operated by a human operator to adjust a position of the single transmitter coil within the wireless charging pad.

In some implementations, the inductive charging system further comprises a user indicator system configured to generate an output indicative of an alignment between the single transmitter coil and the receiver coil of the wireless device. In some implementations, the user indicator system comprises a light.

In some implementations, the control system is configured to adjust the position of the single transmitter coil along a single axis. In some implementations, the control system comprises a slidable member connected to the single transmitter coil and movable along the single axis via a track. In some implementations, the control system comprises a rotary knob connected to the single transmitter coil and rotatable to move the single transmitter coil along the single axis.

In some implementations, the control system is configured to adjust the position of the single transmitter coil along two perpendicular axes.

In some implementations, the wireless charging pad is configured to be mounted atop a surface in a vehicle. In some implementations, the wireless charging pad is attached at an angle relative to vertical to a base member that is configured to be placed on a surface and physically support the wireless charging pad.

According to another aspect of the present disclosure, an inductive charging method is presented. In one exemplary implementation, the inductive charging method comprises providing a wireless charging pad comprising a single transmitter coil that, when active, is configured to inductively couple with a receiver coil of a wireless device placed on the wireless charging pad to wirelessly transfer power thereto, providing a control system configured to adjust a position of the single transmitter coil within the wireless charging pad, and mechanically operating, by a human operator, the control system to adjust the position of the single transmitter coil within the wireless charging pad.

In some implementations, the inductive charging method further comprises providing a user indicator system configured to generate an output indicative of an alignment between the single transmitter coil and the receiver coil of the wireless device, and mechanically adjusting, by the human operator, the control system based on the output generated by the user indicator system. In some implementations, the user indicator system comprises a light.

In some implementations, the control system is configured to adjust the position of the single transmitter coil along a single axis. In some implementations, the control system comprises a slidable member connected to the single transmitter coil and movable along the single axis via a track. In some implementations, the control system comprises a rotary knob connected to the single transmitter coil and rotatable to move the single transmitter coil along the single axis.

In some implementations, the control system is configured to adjust the position of the single transmitter coil along two perpendicular axes.

In some implementations, providing the wireless charging pad comprises mounting the wireless charging pad atop a surface in a vehicle. In some implementations, the wireless charging pad is attached at an angle relative to vertical to a base member that is configured to be placed on a surface and physically support the wireless charging pad.

According to yet another aspect of the present disclosure, an inductive charging system is presented. In one exemplary implementation, the inductive charging system comprises a wireless charging pad means comprising a single transmitter coil means for, when active, inductively coupling with a receiver coil of a wireless device placed on the wireless charging pad to wirelessly transfer power thereto, and a control system means for mechanically operation by a human operator for adjusting a position of the single transmitter coil within the wireless charging pad.

In some implementations, the inductive charging system further comprises a user indicator system means for generating an output indicative of an alignment between the single transmitter coil and the receiver coil of the wireless device.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A-1C are views of an example wireless charging pad comprising a single transmitter coil, an example wireless device comprising a receiver coil, and example consumer electronics implementation of the example wireless charging pad according to the principles of the present disclosure;

FIG. 2 is an overhead view of the example wireless charging pad FIGS. 1A and 1C and a control system and for adjusting the position of the single transmitter coil according to some implementations of the present disclosure; and

FIG. 3 is a flow diagram of an example inductive charging method according to some implementations of the present disclosure.

### DETAILED DESCRIPTION

As previously discussed, conventional wireless charging pads typically comprise a plurality of smaller, closely spaced transmitter coils (i) to more closely match the size of wireless device receiver coils for better inductive coupling and (ii) to allow for spatial freedom in positioning the wireless device. Providing a plurality of transmitter coils, however, increases costs. Accordingly, improved inductive charging systems and methods are presented herein. These inductive charging systems and methods provide a control system for a wireless charging pad comprising a single transmitter coil. The control system is mechanically operated by a human operator to adjust the position of the single transmitter coil within the wireless charging pad, thereby allowing for better alignment with a receiver coil of a wireless device (e.g., a mobile phone). An optional user indicator system could also be provided that generates an output indicative of the alignment between the single transmitter coil and the wireless device. Potential benefits of these inductive charging systems and methods include reduced costs compared to the conventional wireless charging pads comprising a plurality of transmitter coils.

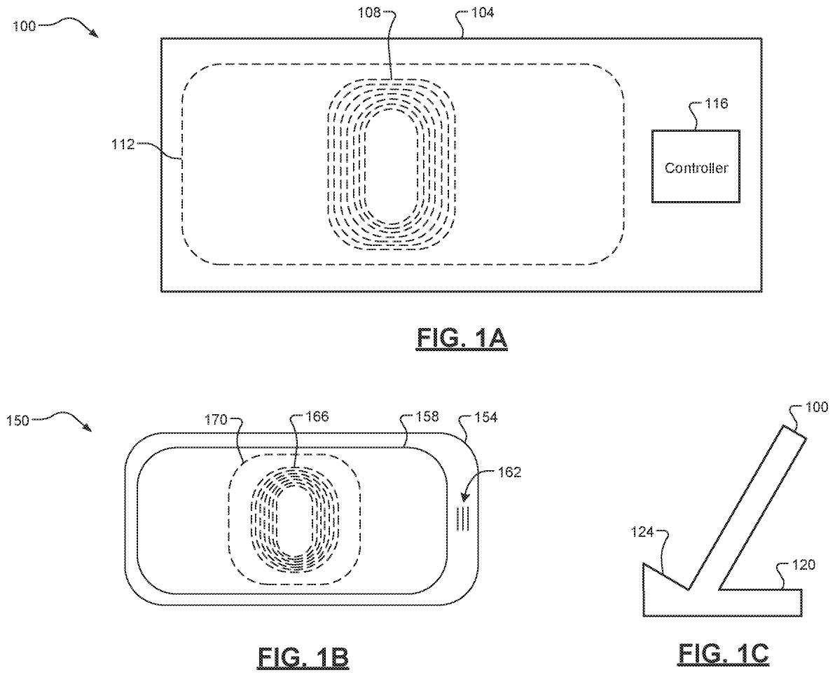

FIGS. 1A-1B illustrate an example wireless charging pad 100 according to some implementations of the present disclosure and an example wireless device 150 (e.g., a mobile phone). The wireless charging pad 100 comprises a housing 104 that houses a single transmitter coil 108 arranged atop a sheet of ferrite material 112. A controller 116 controls operation of the wireless charging pad 100, which primarily includes activating the transmitter coil 108 for wireless charging. While the wireless device 150 is shown to be a mobile phone, it will be appreciated that the wireless device 150 could be any suitable device having a receiver coil configured to receive inductive power. The wireless receiver device 150 comprises a housing 154 that houses various user-facing components (a touch display 158, a speaker/microphone 162, etc.) as well as a receiver coil 166 arranged atop a sheet of ferrite material 170. FIG. 1C illustrates an example consumer electronics implementation (e.g., a table or desk top charger) where the wireless charging pad 100 is attached to a base member 120 at an angle relative to vertical. The wireless device 150 can be laid horizontally or vertically against the wireless charging pad 100 and a lip 124 defined by the base member 120 can further support the wireless device 150.

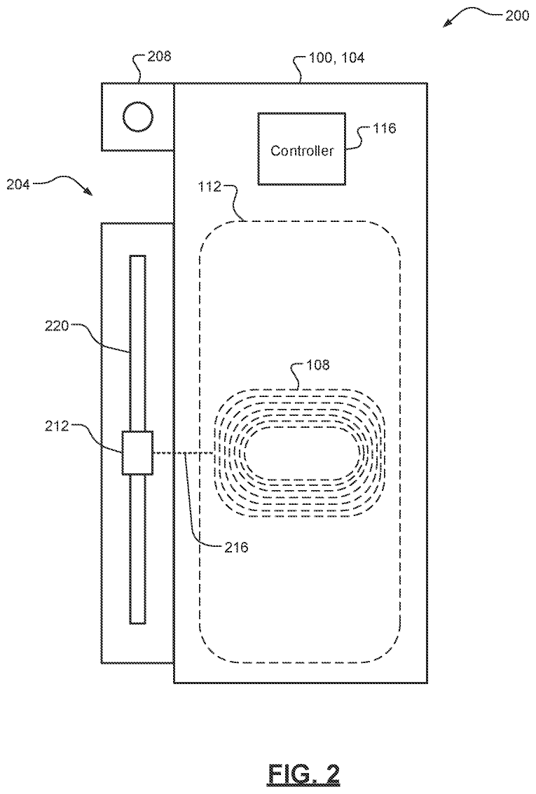

Referring now to FIG. 2, an overhead view of an example inductive charging system 200 according to some implementations of the present disclosure is illustrated. The system 200 generally comprises the wireless charging pad 100, a control system 204, and a user indicator system 208. The control system 204 is configured to be mechanically operated by a human operator (e.g., a vehicle driver or passenger) to adjust a position of the single transmitter coil 108 within the wireless charging pad 100. As shown, the wireless charging pad 100 has a rectangular shape such that the single transmitter coil 108 is only movable along a single axis parallel to the length of the wireless charging pad 100. It will be appreciated, however, that the wireless charging pad 100 could have a square or other shape and that the single transmitter coil 108 could be movable in multiple directions (i.e., along two perpendicular axes). In one exemplary implementation, the control system 204 comprises a slidable member 212 connected to the single transmitter coil 108 via a linkage member 216 and movable along the single axis via a track 220. In an alternate implementation, the control system 204 could comprise a rotary knob connected to the single transmitter coil 108 and rotatable to move the single transmitter coil 108 along the single axis via any suitable linkage system. While shown as a separate system attached to the housing of the wireless charging pad 100, it will be appreciated that the control system 204 and/or the user indicator system 208 could be incorporated into the housing 104 of the wireless charging pad 100 for improved aesthetic appeal.

Because the human operator cannot see the position of the single transmitter coil 108 within the wireless charging pad 100 and its movement in response to mechanically operating the control system 204, the inductive charging system 200 can further comprise the user indicator system 208 being configured to generate an output indicative of an alignment between the single transmitter coil 108 and the receiver coil 166 of the wireless device 150. As shown, the user indicator system 208 comprises a light. For example, the light could illuminate when the single transmitter coil 108 and the receiver coil 166 are properly aligned. This alignment feedback could be obtained by the controller 116, for example, based on a signal strength packet received from the wireless device 150 or based on any other suitable parameters. The controller 116 could then actuate the user indicator system 208, which could result in the light illuminating. It will be appreciated that the light could vary in color (e.g., red—bad alignment, yellow—mediocre alignment, green—proper alignment) or that multiple lights could be used. It will also be appreciated that the user indicator system 208 could generate alternate or additional types of outputs, such as audible sounds and/or haptic vibrations.

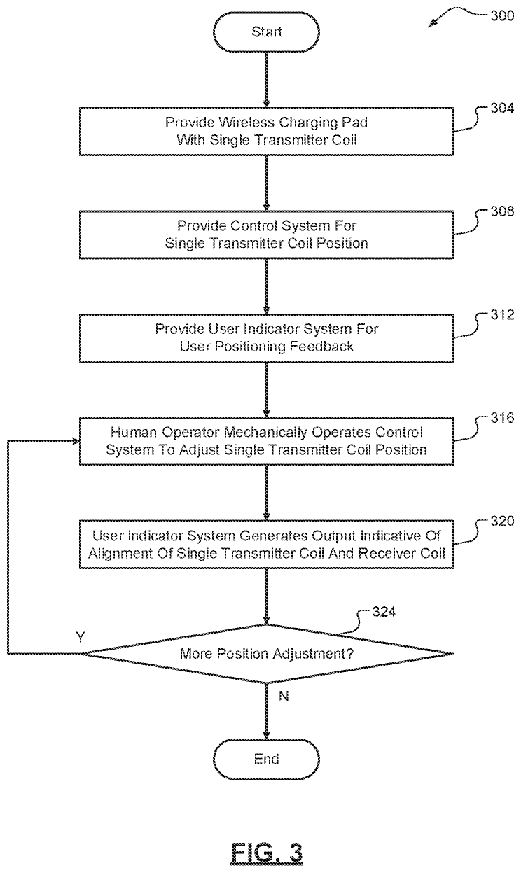

Referring now to FIG. 3, a flow diagram of an example inductive charging method 300 according to the principles of the present disclosure is illustrated. While the method 300 is described with respect to the components of FIGS. 1A-1C and 2, it will be appreciated that the method 300 could be applicable to any inductive charging system. At 304 and 308 and optional 312, the wireless charging pad comprising a single transmitter coil 108, the control system 204, and the user indicator system 208 are provided (e.g., in a vehicle, in a consumer electronics device, etc.). At 316, a human operator (a vehicle driver, a vehicle occupant, etc.) mechanically operates the control system 204 to adjust the position of the single transmitter coil 108 within the wireless charging pad 100. At optional 320 and 324, the user indicator system 208 generates an output indicative of the alignment between the single transmitter coil 108 and the receiver coil 166 of the wireless device 150 and, based on the generated output, the human operator determines whether further position adjustment of the single transmitter coil 108 is required. If true, the method 300 returns to 316. Otherwise, the method 300 ends and an inductive charging session is performed.

It will be appreciated that the control system 204 could further comprise lockable member that could be engaged when proper alignment between the single transmitter coil 108 and the receiver coil 166 has been obtained. This lockable member could be used to temporarily lock the position of the single transmitter coil 108 such that a subsequent accidental actuation of the control system 204 would not cause the single transmitter coil 108 to move and thereby be misaligned with the receiver coil 166, which could cause an interruption in wireless power flow. For example, such an accidental actuation could occur while the vehicle is being operated and in motion.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An inductive charging system, comprising:
a wireless charging pad comprising a single transmitter coil that, when active, is configured to inductively couple with a receiver coil of a wireless device placed on the wireless charging pad to wirelessly transfer power thereto; and
a control system configured to be mechanically operated by a human operator to adjust a position of the single transmitter coil within the wireless charging pad.

2. The inductive charging system of claim 1, further comprising a user indicator system configured to generate an output indicative of an alignment between the single transmitter coil and the receiver coil of the wireless device.

3. The inductive charging system of claim 2, wherein the user indicator system comprises a light.

4. The inductive charging system of claim 1, wherein the control system is configured to adjust the position of the single transmitter coil along a single axis.

5. The inductive charging system of claim 4, wherein the control system comprises a slidable member connected to the single transmitter coil and movable along the single axis via a track.

6. The inductive charging system of claim 4, wherein the control system comprises a rotary knob connected to the single transmitter coil and rotatable to move the single transmitter coil along the single axis.

7. The inductive charging system of claim 1, wherein the control system is configured to adjust the position of the single transmitter coil along two perpendicular axes.

8. The inductive charging system of claim 1, wherein the wireless charging pad is configured to be mounted atop a surface in a vehicle.

9. The inductive charging system of claim 1, wherein the wireless charging pad is attached at an angle relative to vertical to a base member that is configured to be placed on a surface and physically support the wireless charging pad.

10. An inductive charging method, comprising:
providing a wireless charging pad comprising a single transmitter coil that, when active, is configured to inductively couple with a receiver coil of a wireless device placed on the wireless charging pad to wirelessly transfer power thereto;
providing a control system configured to adjust a position of the single transmitter coil within the wireless charging pad; and
mechanically operating, by a human operator, the control system to adjust the position of the single transmitter coil within the wireless charging pad.

11. The inductive charging method of claim 10, further comprising:
providing a user indicator system configured to generate an output indicative of an alignment between the single transmitter coil and the receiver coil of the wireless device; and
mechanically adjusting, by the human operator, the control system based on the output generated by the user indicator system.

12. The inductive charging method of claim 11, wherein the user indicator system comprises a light.

13. The inductive charging method of claim 10, wherein the control system is configured to adjust the position of the single transmitter coil along a single axis.

14. The inductive charging method of claim 13, wherein the control system comprises a slidable member connected to the single transmitter coil and movable along the single axis via a track.

15. The inductive charging method of claim 13, wherein the control system comprises a rotary knob connected to the single transmitter coil and rotatable to move the single transmitter coil along the single axis.

16. The inductive charging method of claim 10, wherein the control system is configured to adjust the position of the single transmitter coil along two perpendicular axes.

17. The inductive charging method of claim 10, wherein providing the wireless charging pad comprises mounting the wireless charging pad atop a surface in a vehicle.

18. The inductive charging method of claim 10, wherein the wireless charging pad is attached at an angle relative to vertical to a base member that is configured to be placed on a surface and physically support the wireless charging pad.

19. An inductive charging system, comprising:
a wireless charging pad means comprising a single transmitter coil means for, when active, inductively coupling with a receiver coil of a wireless device placed on the wireless charging pad to wirelessly transfer power thereto; and
a control system means for mechanically operation by a human operator for adjusting a position of the single transmitter coil within the wireless charging pad.

20. The inductive charging system of claim 19, further comprising a user indicator system means for generating an output indicative of an alignment between the single transmitter coil and the receiver coil of the wireless device.
